(19) United States
(12) Patent Application Publication
(10) Pub. No.: US 2006/0044420 A1
(43) Pub. Date: Mar. 2, 2006

(54) Image pickup apparatus

(75) Inventors: Takuya Iguchi, Nishinomiya-shi (JP); Yoshimasa Okabe, Katano-shi (JP); Yasutoshi Yamamoto, Hirakata-shi (JP); Tatsuo Morita, Osaka-shi (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi (JP)

(21) Appl. No.: 11/212,092

(22) Filed: Aug. 25, 2005

(30) Foreign Application Priority Data
Aug. 26, 2004 (JP) 2004-246668
Dec. 15, 2004 (JP) 2004-362619

(51) Int. Cl. H04N 5/76

(52) U.S. Cl. 348/231.99

(57) ABSTRACT

An image pickup apparatus includes: an image pickup portion for picking up a subject image to generate image data and reading out the generated one frame image data that is divided into plural fields; a storage portion for temporarily storing the image data obtained by performing predetermined processing on the image data that has been read out; and an image processing portion for generating record image data and auxiliary image data for a use other than recording, based on the image data that has been stored in the storage portion. The record image data is generated using image data of all of the fields of the one frame of the image data, and the auxiliary image data is generated using image data of a subset of the fields of the one frame of the image data. The variation of the amount of compressed data is reduced, the processing time is reduced, and the capacity requirement of the buffer memory is reduced.

### BACKGROUND OF THE INVENTION

1. Field of the Invention

The present invention relates to an image pickup apparatus, such as a digital still camera, for recording a still picture after compression coding.

2. Description of Related Art

In a digital still camera, picked up image information is compression coded through a method such as JPEG, and the compression coded data (hereinafter, referred to as “compressed data”) is recorded in a recording device, e.g., a nonvolatile semiconductor memory such as a flash memory. Since the capacity of recording devices is limited, if the amount of the compressed image data varies for respective pictures, then the number of recorded pictures also varies, which is undesirable. Thus, in order to make the data amount for each picture constant, provisional compression coding is performed before compression coding, and based on the code amount of generated compressed data, an appropriate compression rate is calculated. Hereinafter, this process is referred to as “code amount estimation”.

In the following, processing in a conventional digital still camera will be described with reference to the drawings.

FIG. 14 is a block diagram of the conventional digital still camera. In FIG. 14, reference numeral 101 indicates an imaging device, which is driven based on a signal from a timing generator (TG) 102. As for the pixel arrangement of the imaging device 101, the RGB Bayer pattern as shown in FIG. 15 is employed, for example. The imaging device 101 is composed of a CCD image sensor that performs interlaced reading in which image signals for one frame are divided into three fields and read out separately. One frame is constituted by three fields A to C, and in the “A” field, electric charges on every third line starting with the first, i.e. lines 1, 4, . . . , are transferred to a vertical CCD and read out successively. Similarly, in the “B” field, electric charges on lines 2, 5, . . . , and in the “C” field, electric charges on lines 3, 6, . . . are transferred to the vertical CCD and read out successively.

A RAW data generating portion 103 in FIG. 4 converts signals that have been read out from the imaging device 101 into digital signals to generate RAW data. In this specification, “RAW data” refers to data that has been read out from the imaging device and subjected to required processing and that has not yet been converted into YC data. The RAW data of the A, B, and C fields is stored temporarily in a buffer memory 104, and the YC data is generated by a YC processing portion 105. “YC data” refers to a signal in which a luminance signal (Y signal) and a color signal (C signal) are superimposed. YC data processing needs to be performed in the order of the original pixel arrangement shown in FIG. 15. Thus, it is necessary to store the RAW data of the A, B and C fields at every third line in one region in the buffer memory 104 and read out each line successively, or to store the RAW data of the A, B, and C fields in separate regions and read out individual lines of the data of the fields in alternation. The YC data that has been generated by the YC processing portion 105 is stored in a region for the YC data in the buffer memory 104.

The YC data that has been recorded in the buffer memory 104 is compression coded through a method such as JPEG in a compression coding portion 106. In the actual compression, the compressed data is stored in a region for the compressed data in the buffer memory 104, but in code amount estimation, it is not stored in the buffer memory 104, and only the information on the amount of code that has been generated is supplied from the compression coding portion 106 to a compression rate calculation portion 107. The compression rate calculation portion 107 calculates an appropriate compression rate based on the code amount obtained by code amount estimation. In the actual compression, this compression rate is set in the compression coding portion 106. It should be noted that in code amount estimation, the compression coding portion 106 performs compression coding with a provisional compression rate.

The compressed data stored in the buffer memory 104 is recorded in a recording portion 108 constituted by a recording device such as a semiconductor memory. A control portion 109 controls the TG 102, the RAW data generating portion 103, the YC processing portion 105, the compression coding portion 106, the compression rate calculation portion 107, and the recording portion 108, in order to perform these successive processes.

Next, the operation that is performed until the digital still camera having the above-described configuration records image data of one picture will be described. FIG. 16 is a flowchart showing the operation of the control portion 109. First, an appropriate exposure time is determined according to the photographing conditions, and the imaging device 101 is exposed (step S201). Next, the TG 102 is controlled so that the electric charges accumulated in the imaging device 101 are read out in the order of the A, B, and C fields, and signals that have been read out from the imaging device 101 are converted into the RAW data by the RAW data generating portion 103, and the RAW data is stored in the buffer memory 104 (step S202).

Since this digital still camera uses a CCD image sensor that divides image signals for one frame into three fields and reads out them separately, at a time after starting to store the RAW data of the “C” field in the buffer memory 104, the RAW data of the three fields has been completely acquired successively from the top of a picture, and YC data processing can be started. Thus, when storing of the RAW data of the “C” field is started (step S203), the YC processing portion 105 starts to convert the RAW data into the YC data (step S204). Moreover, the YC data that has been generated successively from the top of the image is compression coded by the compression coding portion 106 to start code amount estimation (step S205). In this stage, compression coding is performed for the purpose of code amount estimation, so that the compression coding portion 106 performs compression coding using the provisional compression rate that previously has been stored, and the compressed data is not stored in the buffer memory 104.

When generation of the YC data for one picture is finished, and accordingly code amount estimation also is finished (step S206), the compression rate calculation portion 107 calculates an appropriate compression rate from the amount of code that has been generated (step S207), and the compression coding portion 106 starts the actual compression (step S208). When the actual compression is finished (step S209), the compressed data stored in the buffer memory 104 is recorded in the recording portion 108 (step S210), and thus control for one picture by the control portion 109 is finished.

FIG. 17 is a diagram showing the amount that the buffer memory 104 is used in the above-described configuration. Reference numeral 110 shows the amount used for the RAW data. As the RAW data of the A, B, and C fields is stored in the buffer memory 104, the used amount 110 increases. However, when the procedure for the “C” field is started, since YC data processing is started, as the YC data is generated, the RAW data that is no longer necessary is discarded from the buffer memory 104. Since the amount of the RAW data that becomes unnecessary due to YC data processing is greater than the amount of the RAW data of the “C” field that comes to be stored in the buffer memory 104, the amount 110 in the buffer memory 104 decreases slightly. Then, when storing of the RAW data of the “C” field is finished, only discarding of the RAW data that is no longer necessary due to YC data processing is performed, so that the used amount 110 decreases. Upon termination of generation of the YC data, the amount 110 used for the RAW data becomes 0.

Reference numeral 111 indicates the amount that the buffer memory 104 is used for the YC data. When the procedure for the “C” field is started, as the YC data is stored in the buffer memory 104, the used amount 111 increases. Reference numeral 112 indicates the amount that is used for the compressed data. It should be noted that although code amount estimation is started at almost the same time as generation of the YC data, the compressed data generated by code amount estimation is not stored in the buffer memory 104, so that the amount 112 used for the compressed data is 0 during code amount estimation. After generation of the YC data and code amount estimation are finished, the compression coding portion 106 starts the actual compression, and the amount 112 used for the compressed data increases. On the other hand, the YC data that is no longer necessary is discarded from the buffer memory 104, so that the used amount 111 decreases, and when generation of the compressed data is finished, the used amount 111 becomes 0. The compressed data stored in the buffer memory 104 is recorded in the recording portion 108, and the compressed data that is no longer necessary is discarded from the buffer memory 104, so that the used amount 112 decreases rapidly, and when recording to the recording portion 108 is finished, the used amount 112 becomes 0.

As described above, in the conventional digital still camera, in order to suppress the variation of the code amount for respective pictures, code amount estimation was performed in conjunction with generation of the YC data, and the actual compression was started after code amount estimation was finished. That is to say, compression coding is performed twice, and thus the processing time is long. Moreover, since it is necessary to retain the YC data, which uses the largest amount of the buffer memory, at least until the start of the actual compression, it is necessary to reserve a corresponding capacity of the buffer memory. Moreover, in order to achieve a continuous shooting function, for example, it was necessary to choose whether to increase the memory capacity, leading to an increase in the cost, so as to reserve an even greater capacity, or to increase the time between one shot and a subsequent shot to the extent that the amount used for the YC data decreases.

To address this problem, JP 2003-304491A and JP 2004-088294A, for example, disclose methods for enabling a reduction in the processing time and a reduction in the capacity of the buffer memory while performing code amount estimation.

In the method described in JP 2003-304491A, a reduction in the processing time and a reduction in the capacity of the buffer memory are achieved by dividing the inputted image data into a plurality of small images, thinning out the image data in each unit of the small images, and performing YC data processing and code amount estimation on the resultant data in advance. For example, when the data is thinned out by half the time required for code amount estimation can be reduced almost by half, and it is possible to advance the start of the actual compression by a time period corresponding to that reduction. Moreover, since compression coding can be started at the point of time when the YC data processing is half finished, it is sufficient that half the amount of the YC data is retained in the buffer memory, so that the memory capacity can be reduced.

In the method described in JP 2004-088294A, the RAW data recorded in the buffer memory is compression coded for a single color, and based on the obtained code amount, the compression rate for the actual compression is determined. Thus, it is possible to perform storing of the RAW data in the buffer memory and code amount estimation in parallel, so that the processing time can be reduced.

However, the foregoing conventional techniques have the following problems.

In the method described in JP 2003-304491A, since data is thinned out in groups of small images having predetermined numbers of pixels and lines, when there is a great difference in the amount of image data between before and after thinning out, a code amount estimation error may be increased.

Moreover, in the method described in JP 2004-088294A, since code amount estimation is performed for a single color, when there is a large amount of color information, a code amount estimation error may be increased.

### SUMMARY OF THE INVENTION

It is an object of the present invention to solve the foregoing problems, and to provide an image pickup apparatus with small variation of the amount of the compressed data, a short processing time, and a small capacity of a buffer memory.

The image pickup apparatus of the present invention includes: an image pickup portion that picks up a subject image to generate image data and reads out the generated one frame image data that is divided into plural fields; a storage portion that temporarily stores the image data obtained by performing predetermined processing on the image data that has been read out; and an image processing portion that generates record image data and auxiliary image data for a use other than recording, based on the image data that has been stored in the storage portion. The record image data is generated using image data of all of the fields of the one frame of the image data, and the auxiliary image data is generated using image data of a subset of the fields of the one frame of the image data.

### BRIEF DESCRIPTION OF THE DRAWINGS

FIG. 1 is a block diagram showing a configuration of a digital still camera according to Embodiment 1 of the present invention.

FIG. 2 is a diagram showing a pixel arrangement of a CCD image sensor constituting the digital still camera.

FIG. 3 is a flowchart showing the operation of the digital still camera.

FIG. 4 is a timing chart for describing the operation of the digital still camera.

FIG. 5 is a block diagram showing a configuration of a digital still camera according to Embodiment 2 of the present invention.

FIG. 6 is a flowchart showing the operation of the digital still camera.

FIG. 7 is a flowchart showing the operation of a digital still camera according to Embodiment 3 of the present invention.

FIG. 8 is a timing chart for describing the operation of the digital still camera.

FIG. 9 is a block diagram showing a configuration of a digital still camera according to Embodiment 4 of the present invention.

FIG. 10 is a block diagram showing a configuration example of a part of an image processing portion constituting the digital still camera.

FIG. 11 is a flowchart showing the operation of the digital still camera.

FIG. 12 is a timing chart for describing the operation of the digital still camera.

FIG. 13 is a timing chart for describing the operation in continuous shooting of the digital still camera.

FIG. 14 is a block diagram showing a configuration of a conventional digital still camera.

FIG. 15 is a diagram showing a pixel arrangement of an imaging device in the digital still camera.

FIG. 16 is a flowchart showing the operation of the digital still camera.

FIG. 17 is a diagram showing the amount that a buffer memory is used in the digital still camera.

FIG. 18 is a diagram showing the operation for displaying an image of the digital still camera.

### DETAILED DESCRIPTION OF THE INVENTION

According to the image pickup apparatus of the present invention, code amount estimation can be finished before storing of a single frame of the image data in the storage portion is finished, and furthermore, there is little need to retain the record image data in the storage portion. Therefore, it is possible to provide an image pickup apparatus with small variation of the amount of the compressed data, a short processing time, and a buffer memory with a small capacity requirement.

In the image pickup apparatus of the present invention, the image processing portion can be configured so as to generate the record image data after it has generated the auxiliary image data.

Moreover, the image processing portion can be configured so as to perform compression processing when it generates the record image data, and adjusts a compression parameter in advance, using the auxiliary image data, before the compression processing.

Moreover, the image processing portion can be configured so as to generate the auxiliary image data by performing compression processing on the image data of the subset of the fields, and adjusts the compression parameter that is used during the compression processing of the record image data, using a data size of the auxiliary image data.

In the above-described configuration, a parameter storage portion that stores the compression parameter that has been adjusted further can be provided.

Moreover, it is possible to configure the apparatus such that thumbnail image data is generated based on the auxiliary image data.

Moreover, it is possible to configure the apparatus such that a display image based on the auxiliary image data is displayed on an image monitor.

The image pickup portion can be configured so as to include an AD converter that converts the generated image data from an analog form into a digital form.

The image processing portion can be configured so as to include: a preprocessing portion that performs preliminary processing on the image data that has been generated by the image pickup portion; a YC processing portion that converts the image data that has been subjected to the preliminary processing into YC data composed of a luminance signal and a color-difference signal; and a compression portion that performs compression processing on the converted YC data.

Hereinafter, embodiments of the present invention will be described specifically with reference to the drawings.

### Embodiment 1

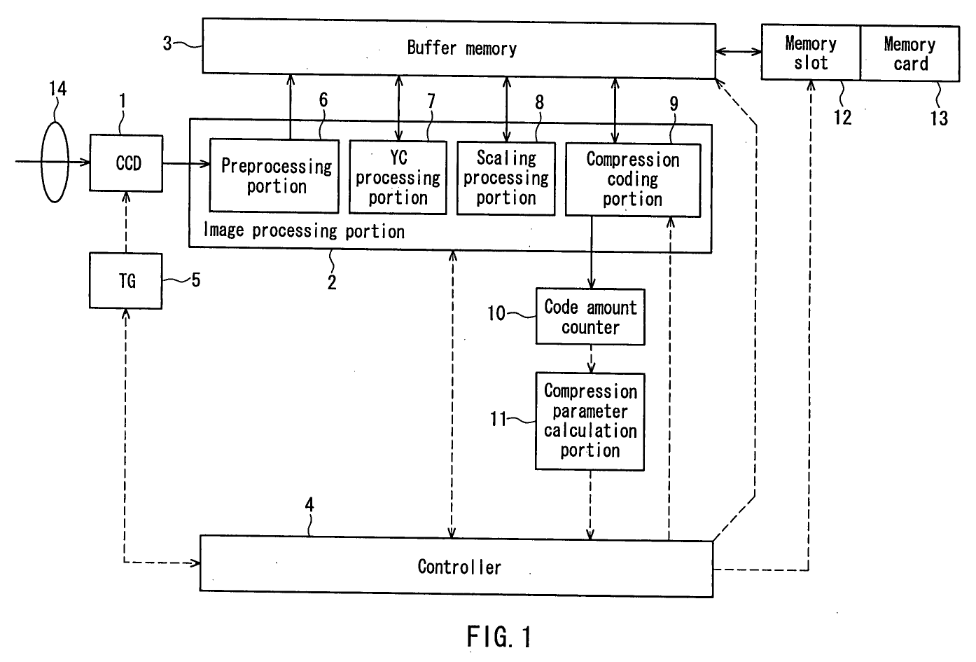

FIG. 1 is a block diagram showing a configuration of a digital still camera according to Embodiment 1 of the present invention. It should be noted that solid arrows in the drawing mean transmission of an image signal, and dashed arrows mean transmission of a control signal.

This digital still camera has a CCD image sensor 1 constituting an image pickup portion, an image processing portion 2 for processing electric signals outputted from the CCD image sensor 1, a buffer memory 3 for temporarily storing the signals that have been processed by the image processing portion 2, and a controller 4 for controlling the overall operation. The CCD image sensor 1 operates based on timing pulses supplied from a timing generator (TG) 5.

The image processing portion 2 includes a preprocessing portion 6, a YC processing portion 7, a scaling processing portion 8, and a compression coding portion 9. An output signal from the compression coding portion 9 is supplied to a code amount counter 10, and an output signal from the code amount counter 10 is supplied to a compression parameter calculation portion 11. An output signal from the compression parameter calculation portion 11 is supplied to the controller 4, and used for controlling. The buffer memory 3 is connected to a memory slot 12, into which a memory card 13 can be inserted, and compressed data stored in the buffer memory 3 can be recorded in the memory card 13.

The CCD image sensor 1 separates an optical image that is incident thereon through an optical system 14 into the three primary colors, R, G, and B, to output pixel signals and supplies them to the preprocessing portion 6. In the preprocessing portion 6, the pixel signals are converted into digital signals, and a gain adjustment is performed based on, for example, pedestal processing and white balance (AWB) processing, so as to create RAW data, which then is stored in the buffer memory 3.

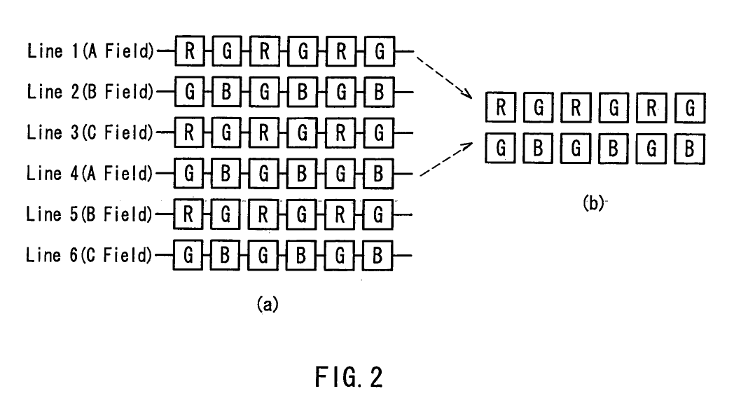

FIG. 2 shows an example of a pixel arrangement of the CCD image sensor 1 according to this embodiment. In FIG. 2, the same portions as in the conventional example shown in FIG. 15 are denoted by the same reference numerals, and similar explanations are not repeated. In the CCD image sensor with a pixel arrangement having a cycle of two lines as shown in (a), signals that have been read out from every third line in the “A” field, such as lines 1, 4, . . . , are as shown in (b). Since the signals are read out from every third line in the pixel arrangement having a cycle of two lines, even the signals of the “A” field alone have the RGB color components, and thus it is possible to perform a code amount estimation including not only the luminance but also the color.

The YC processing portion 7 in FIG. 1 is controlled by the controller 4 to obtain the RAW data from the buffer memory 3 and convert the RAW data into YC data.

The scaling processing portion 8 is provided for the purpose of generating thumbnail images. That is to say, the scaling processing portion 8 is provided with a function of displaying a plurality of thumbnail images on a display so that when the compressed data that has been recorded is to be reproduced on a liquid crystal display and the like mounted on the main unit, an image to be reproduced can be selected conveniently from a large number of recorded pictures. For this purpose, the thumbnail images are generated previously by the scaling processing portion 8 during photographing and recording.

The compression coding portion 9 performs compression coding of the YC data that has been recorded in the buffer memory 3 through a method such as JPEG. In the actual compression, the compressed data is stored in a region for the compression data of the buffer memory 3. On the other hand, in the code amount estimation process, the compressed data is not stored in the buffer memory 3, and only the information about the amount of code that has been generated is supplied from the compression coding portion 9 to the code amount counter 10. The code amount counter 10 measures the code amount of a predetermined number of fields and stores it. The compression parameter calculation portion 11 calculates an appropriate compression parameter based on the code amount that has been measured by the code amount counter 10. In the actual compression, this compression parameter is set in the compression coding portion 9. In the code amount estimation, the compression coding portion 9 performs compression coding based on a provisional compression parameter.

The reason why the code amount is once stored in the code amount counter 10 is as follows: in this embodiment, code amount estimation is performed with respect to only the “A” field, and the actual compression is not started immediately after code amount estimation is finished, so that it is necessary to retain the code amount until the actual compression is started.

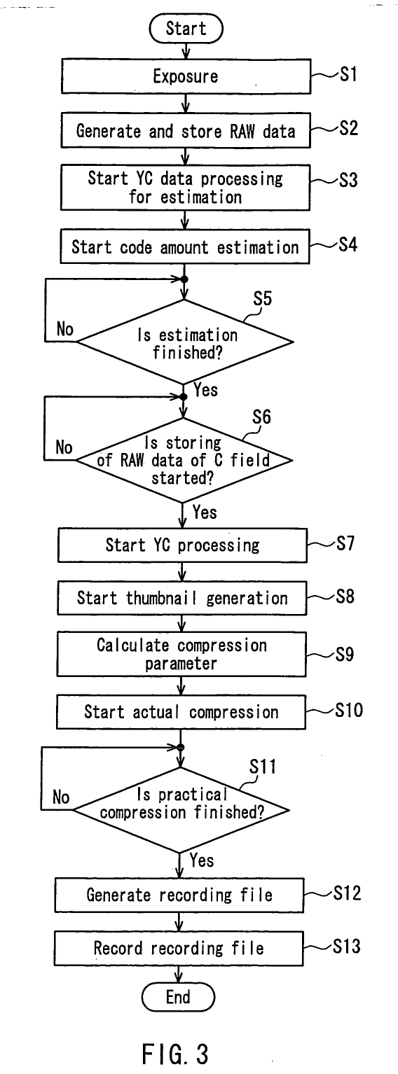

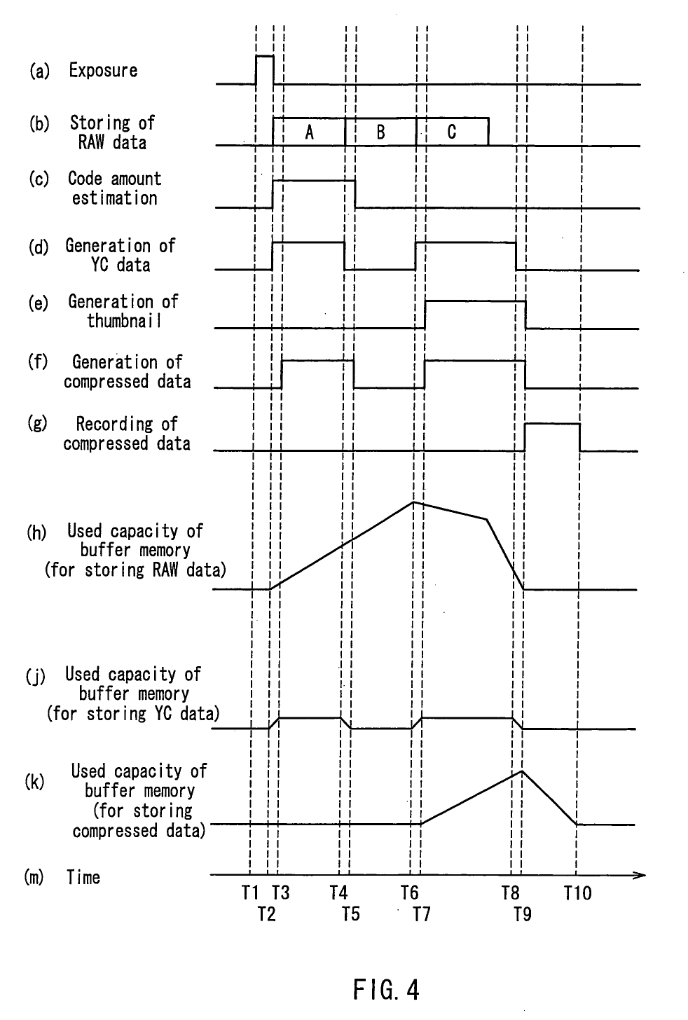

Next, the operation of the digital still camera according to this embodiment will be described with reference to a flowchart shown in FIG. 3 and a timing chart shown in FIG. 4. In the timing chart shown in FIG. 4, the horizontal axis (m) indicates time, and charts (a) to (g) indicate timings of respective actions. Charts (h), (j), and (k) indicate the capacity of the buffer memory 3 that is used.

First, at the time T1, an appropriate exposure time is set according to the photographing conditions, and exposure of the CCD image sensor 1 is performed (step S1). Next, from the time T2, electric charges accumulated in the CCD image sensor 1 are read out in the order of the A, B, and C fields, and the signals that have been read out are converted by the preprocessing portion 6 into the RAW data, which is then stored in the buffer memory 3 (step S2). In this embodiment, after storing of the RAW data is started, when in the “A” field, the RAW data corresponding to a number of lines required for YC data processing is stored in the buffer memory 3, YC data processing for estimation is started (step S3). In FIG. 4, (a) storing of the RAW data, (b) code amount estimation, and (c) generation of the YC data are shown in a manner that these actions start from the same time T2. However, these actions are shown to start from the same time simply for convenience's sake, since it is difficult to illustrate a slight time difference, and actually the actions are started one by one as described above.

YC data processing for estimation is performed on the RAW data of the “A” field shown in FIG. 2, and when the YC data corresponding to the required number of lines for compression coding is stored in the buffer memory (time T3), generation of compressed data for code amount estimation is started (step S4). When storing of the RAW data of the “A” field is finished, YC data processing for estimation is finished accordingly (time T4). Then, generation of the compressed data for code amount estimation also is finished (time T5), and code amount estimation is finished (step S5). The amount of code that has been thus generated is stored in the code amount counter 10.

Then, storing of the RAW data of the “B” field is finished, and at the time T6, storing of the RAW data of the “C” field is started (step S6). Accordingly, YC data processing for the actual compression is started (step S7). At the time T7, generation of the thumbnail images is started (step S8) and also the code amount that has been stored in the code amount counter 10 is read out to the compression parameter calculation portion 11 to calculate a compression parameter (step S9), and the compression parameter is set for the compression coding portion 9. When the YC data corresponding to the required number of lines for compression coding is stored in the buffer memory 3, the actual compression is started (step S10). The compression coding portion 9 stores the compressed data in the buffer memory 3, and when the actual compression is finished at the time T9 (step S11), a recording file is generated (step S12). The recording file is recorded in the memory card 13 (step S13), and when recording is finished at the time T10, processing for one picture is finished.

As described above, in this embodiment, the actual compression can be performed in parallel with YC data processing, so that processing for one picture can be finished earlier than in the conventional example in which the actual compression cannot be started until YC data processing and code amount estimation are finished.

It should be noted that in this specification, the term “record image data” represents the YC data that is generated using the image data of all of the fields constituting one frame or the compressed data that is obtained by compression coding of such YC data and is recorded in a recording medium such as the memory card. In contrast, the term “auxiliary image data” represents the YC data that is generated from the image data of a subset of the fields (one field in this embodiment) for the purpose of YC data processing for estimation. The auxiliary image data may be the compressed data obtained by subjecting the YC data to compression coding processing. The auxiliary image data can be used for a purpose other than code amount estimation as image data for applications other than recording.

Next, a change in the amount that the buffer memory 3 is used will be described with reference to (h), (j), and (k) in FIG. 4. A chart (h) indicates the amount used for the RAW data. As the RAW data of the A, B, and C fields is stored in the buffer memory 3 from the time T2, the used amount (h) increases. When the procedure for the “C” field is started, however, YC data processing is started, so that as the YC data is generated, the RAW data that is no longer necessary is discarded from the buffer memory 3. Since the amount of the RAW data that becomes unnecessary due to YC data processing is greater than the amount of the RAW data of the “C” field that comes to be stored in the buffer memory 3, the amount that the buffer memory 3 is used decreases slightly. Then, when storing of the RAW data of the “C” field is finished, only discarding of the RAW data that is no longer necessary due to YC data processing is performed, so that the used amount (h) decreases rapidly. Upon termination of generation of the YC data, the amount (h) used for the RAW data becomes 0.

A chart (j) indicates the amount that the buffer memory 3 is used for the YC data. The used amount (j) is very small in this embodiment. The reason for this is as follows. First, the YC data for code amount estimation is generated from only the RAW data of the “A” field, and is needed only for the purpose of code amount estimation. The YC data is generated successively from the top of the picture, and when the YC data corresponding to the required number of lines for code amount estimation, e.g., the number of lines in a macroblock in the case of JPEG, is generated, compression coding is started. When compression coding of the macroblock is finished, the corresponding YC data becomes unnecessary and is discarded from the buffer memory 3. Therefore, the amount of the YC data that has to be retained in the buffer memory 3 is of the order of the number of lines in a macroblock. Next, regarding the YC data in the actual compression, in the conventional example, the actual compression was performed after generation of the YC data, and thus it was necessary to retain the YC data in the buffer memory until the start of the actual compression. In contrast, in this embodiment, compression coding is started substantially at the same time as generation of the YC data, and thus it is sufficient that only the amount of the YC data corresponding to about several lines is retained in the buffer memory 3, for the same reason as in code amount estimation.

A chart (k) indicates the amount used for the compressed data. As in the conventional example, the compressed data of the code amount estimation is not stored in the buffer memory 3, but only the data of the actual compression is stored therein, and the compressed data that has been recorded in the memory card 13 and that is no longer necessary is discarded from the buffer memory 3.

As described above, in this embodiment, there is little need to retain the YC data in the buffer memory 3, so that the capacity of the buffer memory 3 can be made smaller than that in the conventional example.

According to this embodiment, since code amount estimation is performed with the luminance and the color signals over the whole part of one picture, it is possible to provide a digital still camera having small variation of the amount of the compressed data, while achieving a short processing time and a small capacity of a buffer memory.

### Embodiment 2

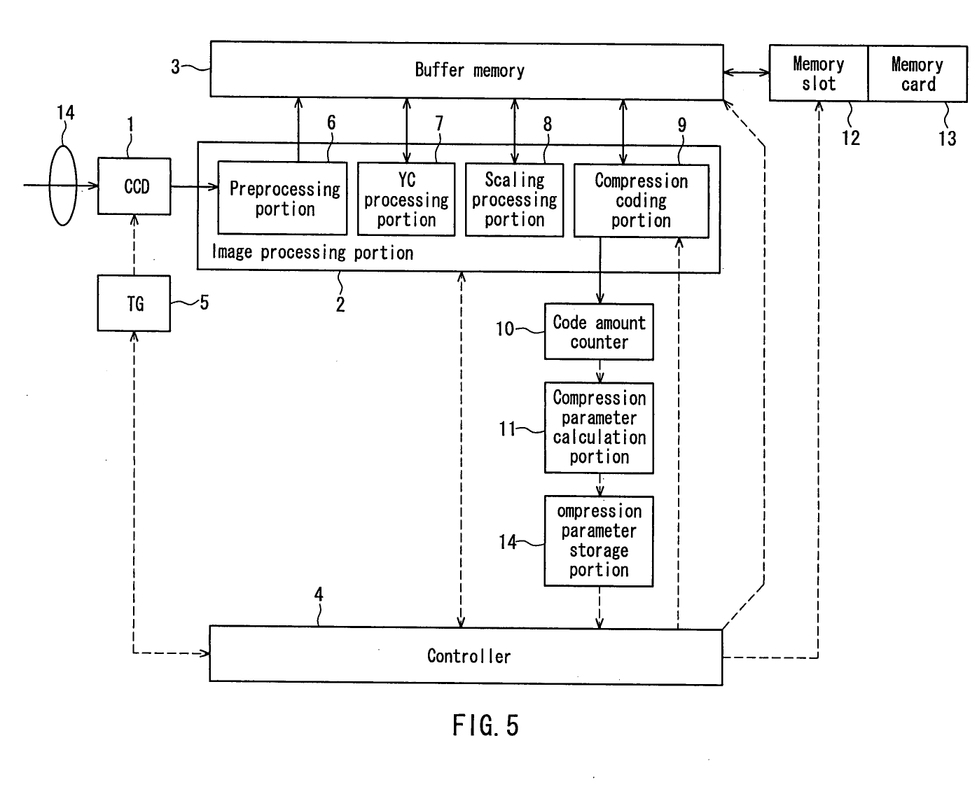

FIG. 5 is a block diagram of a digital still camera according to Embodiment 2 of the present invention. In FIG. 5, the same structures as in FIG. 1 bear the same reference numerals, and redundant explanations have been omitted. In Embodiment 1, the code amount obtained by code amount estimation was stored, whereas, in this embodiment, after code amount estimation is finished, the compression parameter calculation portion 11 calculates an appropriate compression parameter from the obtained code amount, and the calculated compression parameter is stored in a compression parameter storage portion 14. In the actual compression, a compression parameter is set in the compression coding portion 9, based on the compression parameter that has been stored in the compression parameter storage portion 14.

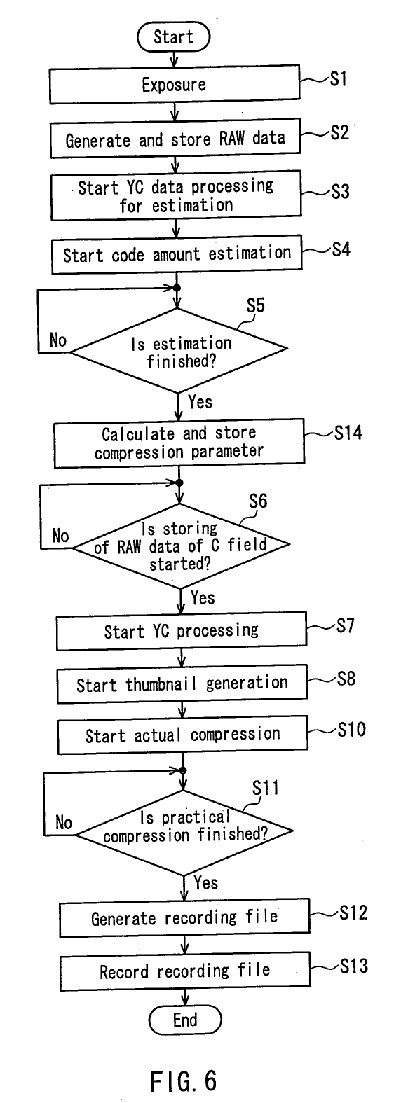

FIG. 6 is a flowchart showing the operation of the digital still camera according to this embodiment. In FIG. 6, the same steps as those in FIG. 3 are denoted by the same reference numerals, and similar explanations are not repeated. In this embodiment, after code amount estimation is finished (step S5), calculation of a compression parameter is performed, and the calculated compression parameter is stored (step S14).

This embodiment is essentially equivalent to Embodiment 1 and can provide similar effects.

### Embodiment 3

A digital still camera according to Embodiment 3 of the present invention has substantially the same configuration as Embodiment 1 shown in FIG. 1. This embodiment is different from Embodiment 1 in the operation relating to generation of the thumbnail images. That is to say, in this embodiment, for the purpose of code amount estimation, the YC data is generated only with the “A” field as in Embodiment 1, so that thumbnail image data is generated by performing reduction processing on this YC data.

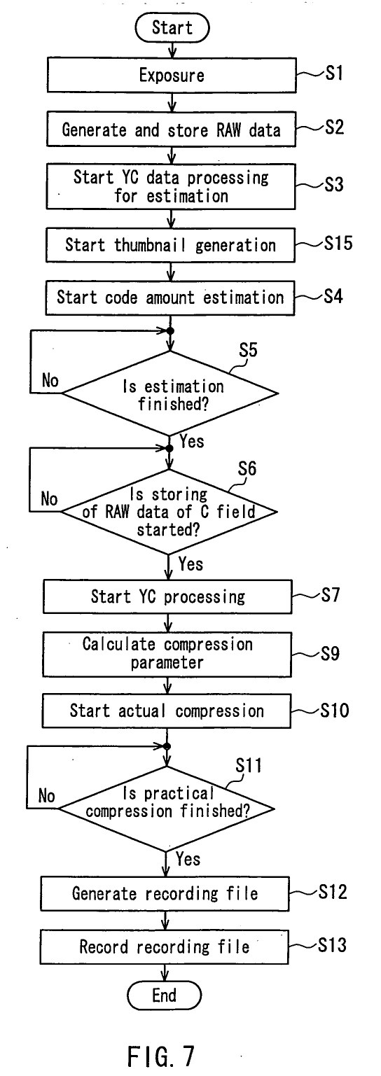

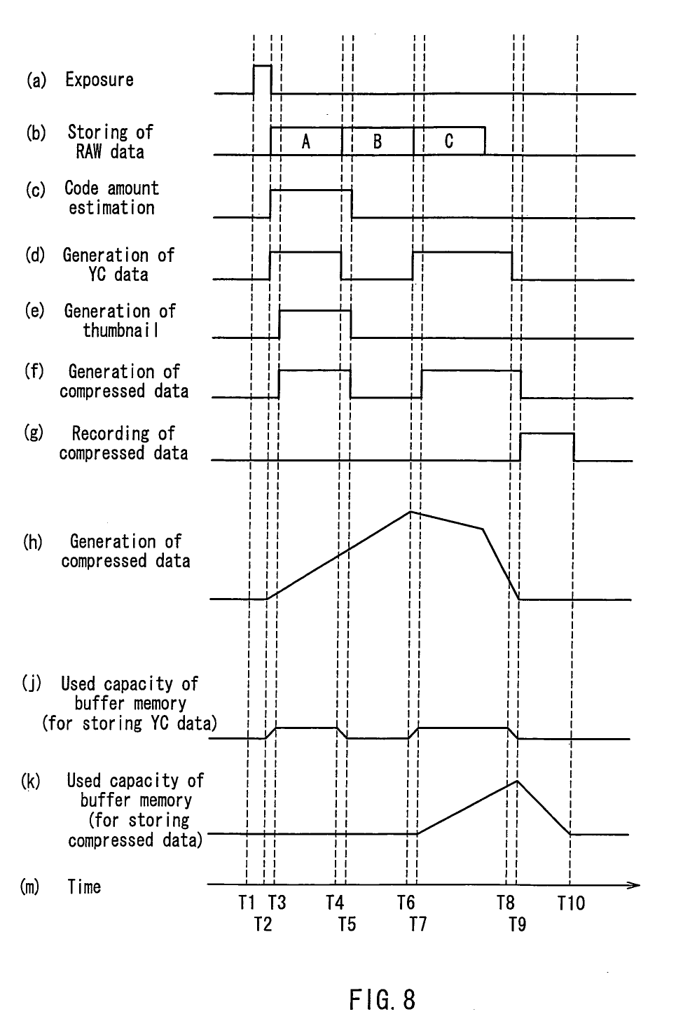

The operation of the digital still camera according to this embodiment will be described with reference to the flowchart shown in FIG. 7 and the timing chart shown in FIG. 8. In FIGS. 7 and 8, the same parts as those in FIGS. 3 and 4 are denoted by the same reference numerals, and similar explanations are not repeated.

In this embodiment, unlike Embodiment 1 shown in FIG. 3, reduction processing for generating a thumbnail image is started (step S15) at almost the same time as the start of YC data processing for estimation (step S4). Then, at almost the same time as the procedure for the “A” field is finished and YC data processing for estimation and code amount estimation are finished, reduction processing also is finished (time T5), and the reduced YC data for thumbnails is recorded in the memory card 13. Instead of recording the YC data for thumbnails directly in this manner, this data also may be compression coded and then recorded.

As described above, in this embodiment, the YC data for thumbnails is generated from only the RAW data of the “A” field, so that no time is needed to generate the thumbnail images even at the time of photographing, not to mention the time of displaying an image. Moreover, there also is no need to retain the YC data of the original image size in the buffer memory in order to generate the thumbnail images. Thus, it is possible to provide a digital still camera with a short processing time and a buffer memory with a small capacity.

Although an example in which reduction processing is used to generate images for thumbnails was discussed in this embodiment, the use of reduction processing is not particularly limited. This embodiment can be applied to the case where it is desired to generate another image having a smaller size than that of a single frame image without requiring the processing time.

### Embodiment 4

A digital still camera according to Embodiment 4 of the present invention has an improved configuration for displaying images on a monitor such as an LCD. The usual digital still camera has a function of displaying an image picked up by the imaging device on an LCD and the like, and a digital still camera often is not provided with an optical view finder. Therefore, a common style of photographing is that a user presses a shutter button while looking at the LCD instead of looking through the view finder, and thus the display quality of the LCD affects the result of photographing.

The image pickup portion of the digital still camera has a monitor mode and a still mode, and the operation thereof differs between those modes. In the monitor mode, the image pickup portion outputs image data of one picture every 1/60 second, but the number of output pixels is small, and the resolution is equivalent to that of a video camera. On the other hand, in the still mode, the image pickup portion outputs image data with a higher resolution and a higher pixel count, but it takes a relatively long time to output due to the large number of pixels. Thus, it takes a long time from reading out of picked up image data until displaying of the image data on the LCD (display time lag). In the monitor mode, the display time lag is short, i.e., about 1/30 second, whereas in the still mode, the display time lag reaches ¼ second to ½ second and is thus very long.

If displaying on the LCD is delayed, then recognition of a movement of a subject is delayed. In particular, since a continuous shooting mode in which still photographing is performed continuously is aimed at photographing a moving subject, if displaying on the LCD is delayed, then it is difficult to operate the camera following the movements of the subject. Consequently, images that do not capture the subject accurately are recorded.

The reason why the display time lag is long in the still mode will be described with reference to FIG. 18. FIG. 18 shows the operation for displaying images on the LCD in the still mode. The top row chart shows a transition of image data X in RGB format. The middle row chart shows a period during which display image data (data for displaying an image) Y is outputted. Symbol Z in the bottom row indicates a period Z during which the image is displayed. Numerals in respective cells represent frame numbers of the images, and the same numerals indicate the same frames. Symbols A, B, and C indicate the respective fields.

The image data X is outputted successively, such as in the order of fields 1A, 1B, and 1C in the first frame, fields 2A, 2B, and 2C in the second frame, and so on. As the image data X of the “C” field in each frame is outputted, generation of the display image data Y is started, and from the point of time at which generation of one frame of the display image data Y is completed, the image display period Z for the relevant frame is started. Since the display time lag L is the time from when outputting of the image data X of the “A” field is started until generation of the display image data Y is completed, it is extended significantly as described above.

According to this embodiment, by using the YC data generated from only the data of the “A” field for the purpose of code amount estimation, the images can be displayed on the monitor with a reduced display time lag L.

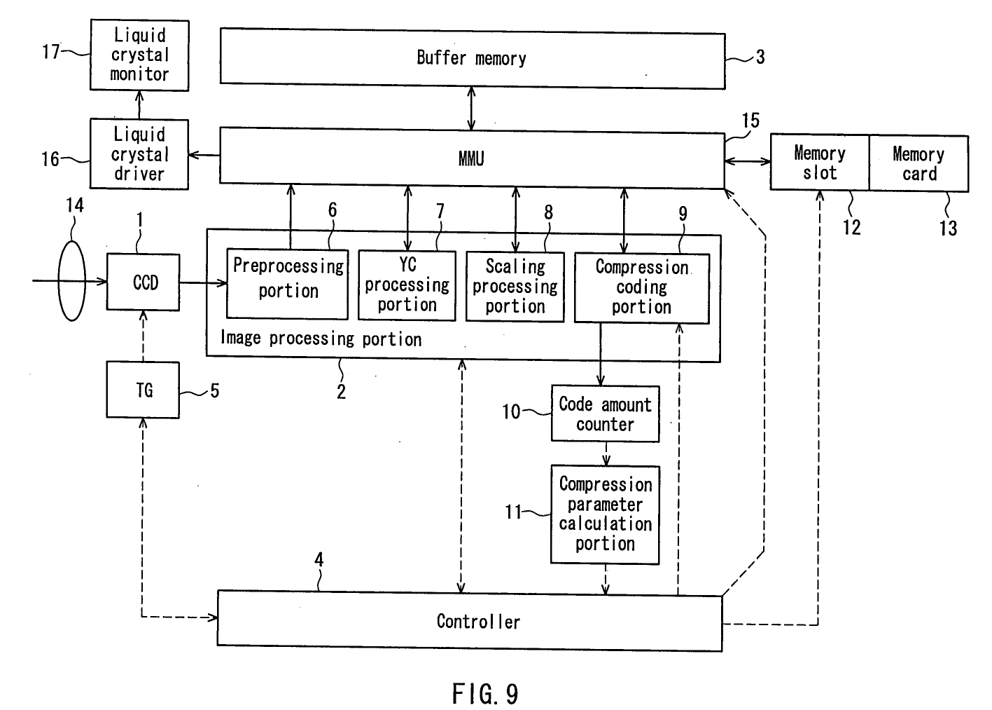

FIG. 9 is a block diagram of the digital still camera according to Embodiment 4 of the present invention. In FIG. 9, the same structures as in Embodiment 1 shown in FIG. 1 are denoted by the same reference numerals, and similar explanations are not repeated.

This digital still camera is different from Embodiment 1 shown in FIG. 1 with regard to a display image data generating method for displaying an image by driving a liquid crystal monitor 17 with a liquid crystal driver 16. Moreover, it is different from Embodiment 1 with regard to a configuration in which the buffer memory 3 is managed via a memory managing unit (MMU) 15.

Moreover, the image processing portion 2 operates in two modes, i.e., a display picture mode and a recording picture mode, and the modes are switched by a mode switching signal supplied from the controller 4. In the recording picture mode, image data in RGB format is read out from the buffer memory 3 via the MMU 15, and YC data adapted to the number of recorded pixels is generated and written back to a region for the YC data for recording images in the buffer memory 3. In the display picture mode, the image data in RGB format is read out from the buffer memory 3 via the MMU 15, and YC data adapted to the number of display pixels is generated and written back to a region for the YC data for display images in the buffer memory 3.

The MMU 15 is provided with a function of dynamically allocating the memory using on demand paging and a function of automatically recovering pages that are no longer necessary. For example, when the CCD image sensor 1 outputs the image data in RGB format, one page of the memory is allocated automatically to the image data in RGB format at the point of time when the pixel data is stored first, and as soon as the CCD image sensor 1 finishes writing to the one page of the memory, the next page of the memory is newly allocated for the image data in RGB format. Moreover, when the image processing portion 2 reads out the image data in RGB format, each time the image processing portion 2 finishes reading of one page of the memory for the image data in RGB format, the page that is no longer necessary is recovered automatically and turned into an empty page, and then used again in the next allocation.

The liquid crystal driver 16 reads out the YC data from the region for the YC data for display images in the buffer memory 3 via the MMU 15, and displays it on the liquid crystal monitor 17. For the display data region, pages are fixedly allocated because reading-out is performed repeatedly, and the MMU 15 does not recover the pages automatically.

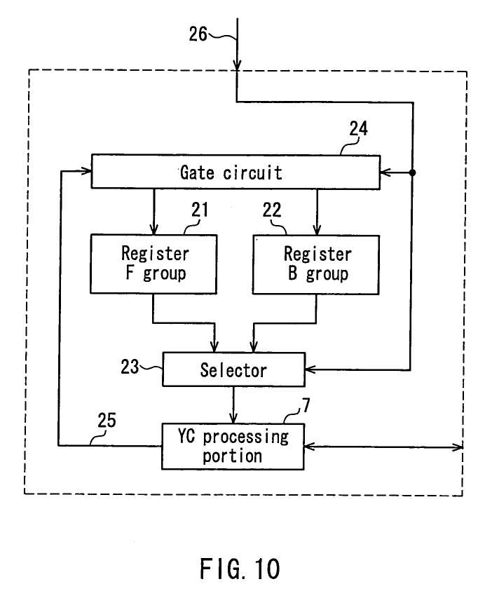

Next, a configuration involved in YC data processing by the image processing portion 2 will be described with reference to FIG. 10. FIG. 10 is a block diagram showing a configuration of a part of the image processing portion 2. A register F group 21 and a register B group 22 are connected to the YC processing portion 7 via a selector 23. Each of the register F group 21 and the register B group 22 instructs the operation of the YC processing portion 7. The instruction contains a leading address of the RGB data region and a leading address of the YC data region. An output from the register F group 21 or the register B group 22 is selected by the selector 23, and only the instruction of one group is given to the YC processing portion 7.

The YC processing portion 7 performs reading-out of the RGB data, conversion of the data, and storing of the YC data according to the instruction, and outputs a trigger pulse group 25 in synchronization with reading-out and storing. This trigger pulse group 25 refers to pulses for updating the leading address of the RGB data and the leading address of the YC data in accordance with the progress of storing and reading-out. The trigger pulse group 25 is given, via a gate circuit 24, only to one register group of the register F group 21 or the register B group 22 that is selected by the selector 23, and updates the value of each register. Selection by the selector 23 and the gate circuit 24 is performed by the mode switching signal 26.

Next, the operation during mode switching will be described. In the recording picture mode, the register B group 22 is selected, and the leading address of the RGB data and the leading address of the YC data in the register B group 22 are incremented in accordance with the progress of processing. When the mode switching signal 26 is changed at a certain point of time and the mode is switched to the display picture mode, the register F group 21 is selected in place of the register B group 22, and the register B group 22 no longer is changed. When the mode switching signal 26 is changed again and the mode is switched back to the recording picture mode, the YC processing portion 7 can resume the processing of the recording images from where the processing was interrupted since the leading address of the RGB data and the leading address of the YC data in the register B group 22 are kept in a state immediately before the processing of the recording images was stopped.

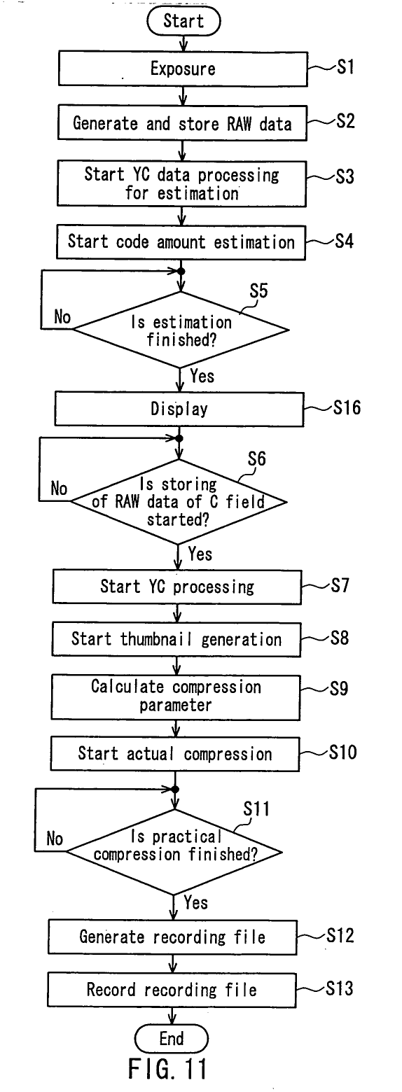

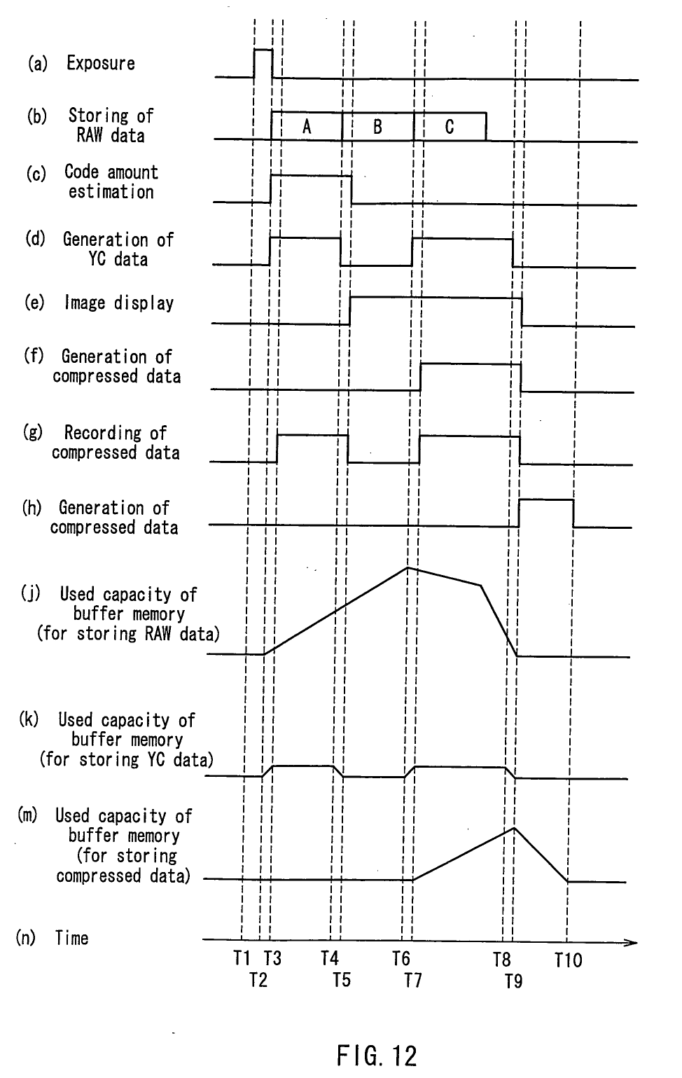

The operation of the digital still camera according to this embodiment will be described with reference to the flowchart shown in FIG. 11 and the timing chart shown in FIG. 12. In FIGS. 11 and 12, the same parts as those in FIGS. 3 and 4 are denoted by the same reference numerals, and similar explanations are not repeated.

This embodiment is different from Embodiment 1 in that at almost the same time (time T5 in FIG. 12) as YC data processing for estimation is finished (step S5), image display (c) is started (step S16).

When the photographing operation is started, the preprocessing portion 6 divides the image data in RGB format into three fields and stores them, as shown in FIG. 12(b). At the same time, the preprocessing portion 6 sends information of the number of stored lines to the controller 4 as a line number signal, and the controller 4 activates the YC processing portion 7 in the display picture mode. As shown in FIG. 12(d), the YC processing portion 7 reads out the image data in RGB format from the buffer memory 3 in synchronization with storing by the preprocessing portion 6 (time T2), generates the YC data adapted to the number of display pixels from this data, and writes the generated YC data back to the buffer memory 3. When generation of the YC data of the “A” field is finished (time T4), image display of the relevant frame is started (time T5), as shown in FIG. 12(e). Consequently, the display time lag is shorter than that in the conventional example shown in FIG. 18 by an amount that is equal to or greater than the period for outputting the RGB image data for two fields.

In this manner, in the digital still camera according to this embodiment, generation of the YC data is performed twice each time one frame is photographed. The first YC data is generated for displaying images, and the YC data is generated at the same time as the CCD image sensor 1 outputs the RGB data of the first “A” field, so that it is possible to update the display image in the shortest period of time. The second YC data is generated for recording images, and the YC data is generated with reference to the RGB data of all of the fields, so that it is possible to record an image free from deterioration in resolution.

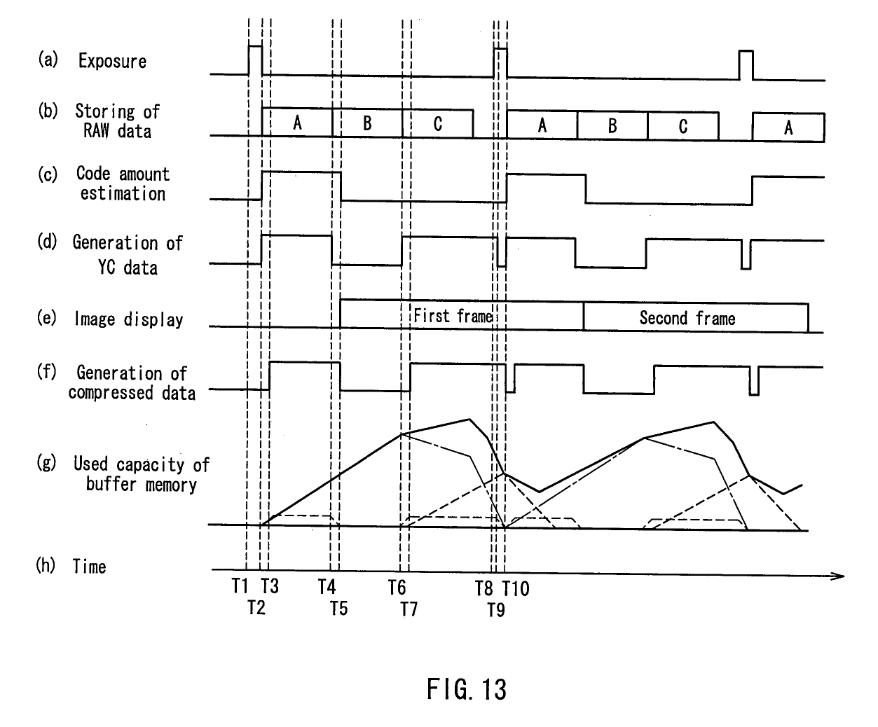

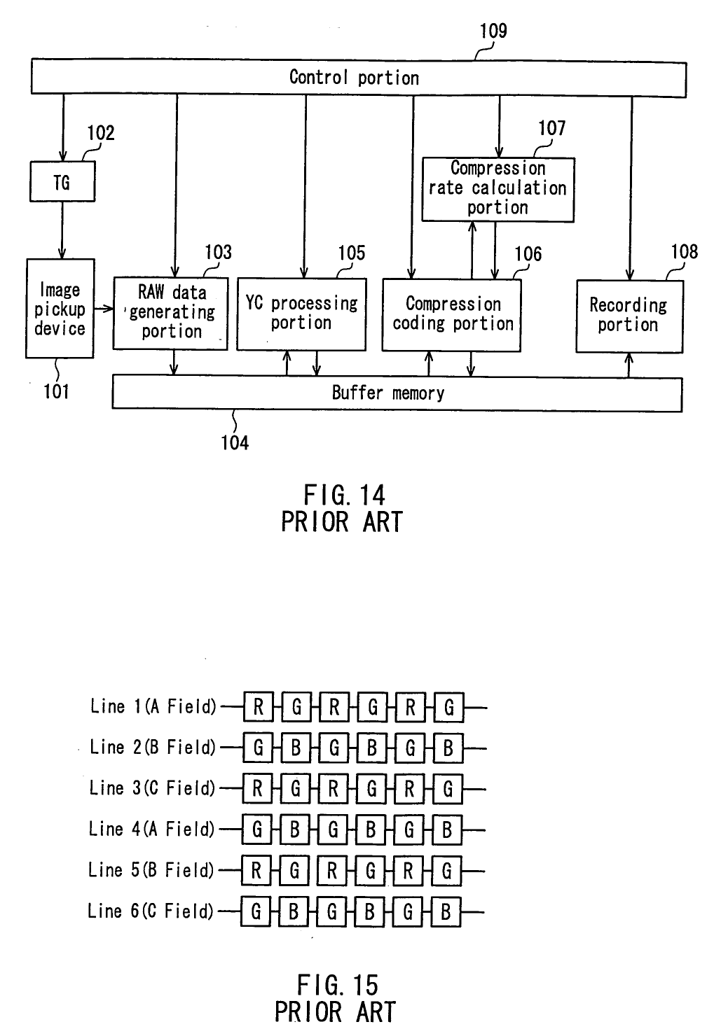

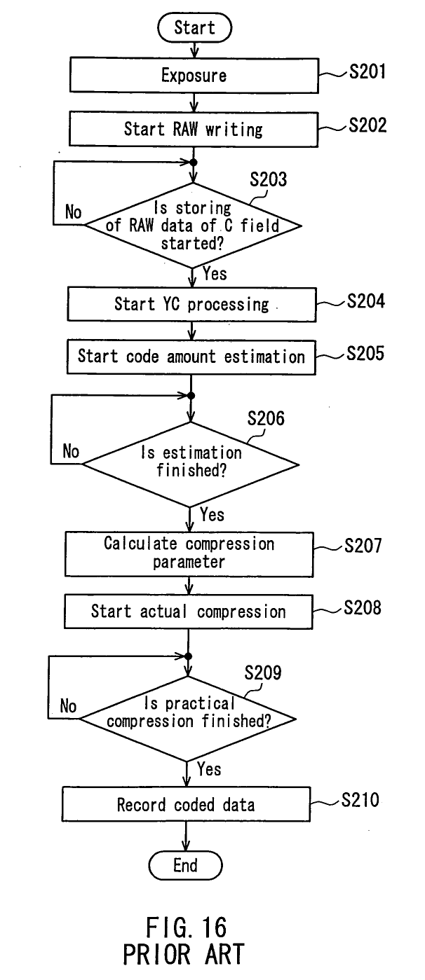

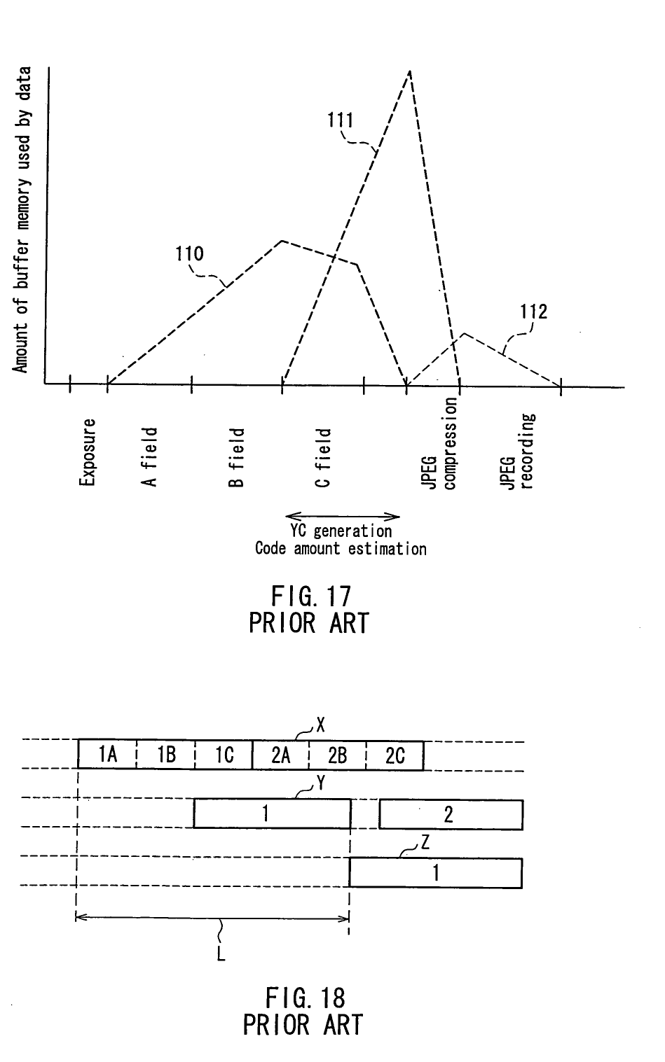

Next, the operation in continuous shooting will be described with reference to FIG. 13. FIG. 13 shows a timing chart in which the same timing chart as in FIG. 12 is repeated continuously for two frames. However, in the used capacity (h) of the buffer memory, the capacities used for the RAW data, the YC data, and the compressed data are shown overlapped.

In continuous shooting, the period for generation of the record image data, which is finished at the time T10 in FIG. 13(f), and the period for output of the image data in RGB format of the “A” field in the next frame, i.e., the period for generation of the image data for display, which is started at the time T10 in FIG. 13(b), may be overlapped. The two periods are overlapped when the compressed data generation process is not finished by the time storing of the RAW data of the “A” field in the next frame is started, because of a large number of pixels of the recording image.

In contrast, in the digital still camera according to this embodiment, the image processing portion 2 has the two modes, i.e., the display picture mode and the recording picture mode, and by switching between the modes alternately, it is possible to generate the display image data and the recording image data in parallel in a pseudo manner. At this time, the controller 4 controls the mode switching signal so that the display image is generated preferentially. More specifically, when the preprocessing portion 6 outputs sixty-four lines of the image data, the controller 4 performs control such that it switches the mode switching signal so as to put the YC processing portion 7 into the display picture mode, waits until the YC processing portion 7 finishes processing the sixty-four lines of the image data, and then switches the mode switching signal back to the recording picture mode. By performing control in this manner, the display image is generated without delay, and the remaining processing time is assigned to generation of the recording image for the previous frame, without being wasted.

When the function of operating the YC processing portion 7 to perform time-sharing parallel processing is not provided, generation of a recording image may be stopped temporarily during processing of the “A” field in the next frame to start generation of a display image, and at the point of time when processing of the “A” field is finished and generation of the display image is completed, generation of the recording image may be resumed.

The operation of the compression coding portion 9 for the second frame is a little irregular because the compression coding portion 9 does not have a function of performing time-sharing parallel processing as that of the YC processing portion 7. First, when display image data of the second frame is generated, since compression coding of recording image data of the previous frame is not yet completed, compression coding of the display image data of the second frame is not started until compression coding of the recording image data is completed. Ike the first frame, a parameter of compression coding for the second frame also is optimized according to the result of compression coding of the display image. The compression coding portion 9 waits until the YC processing portion 7 starts to generate record image data of the second frame, and then starts compression coding of the recording image data, and at this time, the compression coding portion 9 uses the parameter that is optimized based on compression coding of the display image data.

In this manner, the timing of the processing operation of the compression coding portion 9 for the second frame may not necessarily coincide with the timing at which the YC processing portion 7 generates the recording image data. However, unlike generation of the display image, the compression coding process does not cause an unsatisfactory appearance, and also it is sufficient that compression coding of the display image data of the second frame is finished before the start of compression coding of the recording image data of the second frame, so that there is no problem even when the compression coding portion 9 does not have a function of performing time-sharing parallel processing as that of the YC processing portion 7.

In this embodiment, the parameter is optimized based on the result of compression coding of the display image data. However, when there is a great difference in the number of pixels between the recording image data and the display image data, it is possible that a prediction error of the amount of JPEG data is increased. In this case, a trial image for compression coding may be generated at the same time as generation of the display image data or before or after generation of the display image data, and the parameter may be optimized based on the result of compression coding of the trial image. If the trial image is generated as an image having the number of pixels that is adapted to the number of recorded pixels, then the prediction error of the amount of JPEG data can be made smaller than in the case where the display image data having a number of pixels significantly different from that of the recording image data is compression coded.

Moreover, as another method, it is also possible that only a trial image is generated without generating the display image data, and the liquid crystal driver 16 thins out pixel data of the trial image and displays the resultant image on the liquid crystal monitor. When employing this method, it is possible to perform the operation of thinning out easily if the numbers of pixels in the horizontal direction and the vertical direction of the trial image respectively are set to integral multiples of the numbers of pixels in the horizontal direction and the vertical direction of the display image.

In the foregoing embodiments, an example in which the auxiliary image data (YC data) is generated based on only the image data of the “A” field was discussed. However, the YC data may be generated based on the image data of a plurality of fields constituting a subset of one frame. With this method, it is possible to increase the accuracy of code amount estimation. Moreover, also when data for all of the colors cannot be completed with the image data of one field alone, it is desirable to generate the auxiliary image data using the image data of a plurality of fields. Moreover, in order to achieve the effect of the invention sufficiently, it is desirable to generate the auxiliary image data using the image data of a subset of the fields that is read out earlier.

It should be noted that the image pickup portion is not limited to the CCD image sensor, and it is also possible to use a CMOS image sensor, for example. The AD converter may be contained in the image pickup portion or may be attached outside thereof.

The image processing portion may be constituted by a hardware circuit such as a DSP or may be constituted by a micro computer using a software. The image processing portion, the code amount counter, the compression parameter calculation portion, and the controller can be configured on a single chip.

The buffer memory may be constituted by a single memory or may be constituted by a plurality of memories. Moreover, the buffer memory may be controlled directly by the controller as in, for example, Embodiment 1 described above, or may be controlled using the MMU as in Embodiment 4.

The memory for recording may be a detachable memory card or may be an internal memory.

Although the RAW data was described as the RGB data, the RAW data may be complementary color image data. The imaging device may be configured so as to output the YC data instead of the RGB data.

A configuration in which non-compressed data, instead of the compressed data, is recorded in the memory card also is possible.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. An image pickup apparatus, comprising:
an image pickup portion that picks up a subject image to generate image data and reads out the generated one frame image data that is divided into plural fields;
a storage portion that temporarily stores the image data obtained by performing predetermined processing on the image data that has been read out; and
an image processing portion that generates record image data and auxiliary image data for a use other than recording, based on the image data that has been stored in the storage portion,
wherein the record image data is generated using image data of all of the fields of the one frame of the image data, and the auxiliary image data is generated using image data of a subset of the fields of the one frame of the image data.

2. The image pickup apparatus according to claim 1, wherein the image processing portion generates the record image data after it has generated the auxiliary image data.

3. The image pickup apparatus according to claim 2, wherein the image processing portion performs compression processing when it generates the record image data, and adjusts a compression parameter in advance, using the auxiliary image data, before the compression processing.

4. The image pickup apparatus according to claim 3, wherein the image processing portion generates the auxiliary image data by performing compression processing on the image data of the subset of the fields, and adjusts the compression parameter that is used during the compression processing of the record image data, using a data size of the auxiliary image data.

5. The image pickup apparatus according to claim 3, further comprising a parameter storage portion that stores the compression parameter that has been adjusted.

6. The image pickup apparatus according to claim 1, wherein thumbnail image data is generated based on the auxiliary image data.

7. The image pickup apparatus according to claim 1, wherein a display image based on the auxiliary image data is displayed on an image monitor.

8. The image pickup apparatus according to claim 1, wherein the image pickup portion comprises an AD converter that converts the generated image data from an analog form into a digital form.

9. The image pickup apparatus according to claim 1, wherein the image processing portion comprises:
a preprocessing portion that performs preliminary processing on the image data that has been generated by the image pickup portion;
a YC processing portion that converts the image data that has been subjected to the preliminary processing into YC data composed of a luminance signal and a color-difference signal; and
a compression portion that performs compression processing on the converted YC data.
